(19) United States
(12) Patent Application Publication
(10) Pub. No.: US 2023/0004857 A1
(43) Pub. Date: Jan. 5, 2023

(54) TECHNIQUES FOR VALIDATING MACHINE LEARNING MODELS

(71) Applicant: Armis Security Ltd., Tel Aviv-Yafo (IL)

(72) Inventors: Ron SHOHAM, Tel Aviv (IL); Yuval FRIEDLANDER, Petah-Tiqwa (IL); Tom HANETZ, Tel Aviv (IL); Gil BEN ZVI, Hod Hasharon (IL)

(73) Assignee: Armis Security Ltd., Tel Aviv-Yafo (IL)

(21) Appl. No.: 17/364,088

(22) Filed: Jun. 30, 2021

(51) Int. Cl. G06N 20/00; G06N 7/00; G06K 9/62

(52) U.S. Cl. CPC G06N 20/00; G06N 7/005; G06K 9/6262; G06K 9/6202; G06K 9/623; G06K 9/6218

(57) ABSTRACT

A system and method for machine learning model validation. A method includes: determining a first score distribution for a first run of a machine learning model and a second score distribution for a second run of the machine learning model, wherein the first run includes applying the machine learning model to a first test dataset, wherein the second run includes applying the machine learning model to a second test dataset, wherein the second test dataset is collected after the first test dataset; comparing the first score distribution to the second score distribution; determining, based on the comparison, whether the machine learning model is validated; continuing use of the machine learning model when it is determined that the machine learning model is validated; and performing at least one rehabilitative action with respect to the machine learning model when it is determined that the machine learning model is not validated.

### TECHNICAL FIELD

The present disclosure relates generally to validation of machine learning models, and more specifically to performance of machine learning models.

### BACKGROUND

In machine learning, model validation is a process by which a trained model is evaluated using a test data set. The test data set may be a subset of the data set from which training data was derived and is used to ensure that the model is able to appropriately generalize the test data in order to arrive at a correct outcome. Various general methods of validation have been developed, with different methods suitable for different use cases. Improving validation techniques to result in better trained model is an ongoing challenge in every field in which machine learning models are used.

Further, machine learning models may decay in performance over time due to macro level trends and patterns that can adversely affect the quality of the model when applied to subsequent data. Consequently, models may need to be trained periodically using new data in order to maintain performance. Existing solutions face challenges in identifying deviations in model performance in order to maintain adequate performance over time.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for machine learning model validation. The method comprises: determining a first score distribution for a first run of a machine learning model and a second score distribution for a second run of the machine learning model, wherein the first run includes applying the machine learning model to a first test dataset, wherein the second run includes applying the machine learning model to a second test dataset, wherein the second test dataset is collected after the first test dataset; comparing the first score distribution to the second score distribution; determining, based on the comparison, whether the machine learning model is validated; continuing use of the machine learning model when it is determined that the machine learning model is validated; and performing at least one rehabilitative action with respect to the machine learning model when it is determined that the machine learning model is not validated.

Certain embodiments disclosed herein also include a non-transitory computer readable medium having stored thereon causing a processing circuitry to execute a process, the process comprising: determining a first score distribution for a first run of a machine learning model and a second score distribution for a second run of the machine learning model, wherein the first run includes applying the machine learning model to a first test dataset, wherein the second run includes applying the machine learning model to a second test dataset, wherein the second test dataset is collected after the first test dataset; comparing the first score distribution to the second score distribution; determining, based on the comparison, whether the machine learning model is validated; continuing use of the machine learning model when it is determined that the machine learning model is validated; and performing at least one rehabilitative action with respect to the machine learning model when it is determined that the machine learning model is not validated.

Certain embodiments disclosed herein also include a system for machine learning model validation. The system comprises: a processing circuitry; and a memory, the memory containing instructions that, when executed by the processing circuitry, configure the system to: determine a first score distribution for a first run of a machine learning model and a second score distribution for a second run of the machine learning model, wherein the first run includes applying the machine learning model to a first test dataset, wherein the second run includes applying the machine learning model to a second test dataset, wherein the second test dataset is collected after the first test dataset; comparing the first score distribution to the second score distribution; determine, based on the comparison, whether the machine learning model is validated; continue use of the machine learning model when it is determined that the machine learning model is validated; and perform at least one rehabilitative action with respect to the machine learning model when it is determined that the machine learning model is not validated.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for training a machine learning model using validation according to an embodiment.

FIG. 3 is a flowchart illustrating a method for metrics validation according to an embodiment.

FIG. 4 is a flowchart illustrating a method for scoring validation according to an embodiment.

FIG. 5 is a flowchart illustrating a method for comparing score distributions according to an embodiment.

FIG. 6 is a flowchart illustrating a method for validating features according to an embodiment.

FIG. 7 is a schematic diagram of a validator according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In light of the ongoing need for improved validation techniques and more specifically for identifying potential deviations in model performance, the embodiments disclosed herein include techniques for validating machine learning models. Specifically, the disclosed embodiments include respective methods and systems for validating machine learning models for performance as measured with respect to metrics and scores. The disclosed embodiments provide validation techniques which allow for monitoring performance over time in order to ensure that validated machine learning models remain accurate and precise. Consequently, the disclosed embodiments can be utilized to determine whether a model is sufficiently accurate and precise, thereby improving the training and use of such machine learning models.

In this regard, it has been identified that degradation in machine learning model performance over time may be reflected in statistical changes in metrics, scores, or a combination thereof. These statistical changes can be measured using the techniques described herein by comparing results of different runs of the model conducted over time. The disclosed embodiments further include techniques for determining whether a more recent run is indicative of a less accurate machine learning process and, therefore, allows for identifying when a current model has degraded in performance and therefore one or more rehabilitative actions should be performed to avoid inaccurate outputs.

In various embodiments, a machine learning model is trained using a training data set. Once trained, the model is applied in various runs over time during a test phase. Validation is performed to determine whether the model is sufficiently well trained based on the runs during the test phase. When the model is not validated, rehabilitative actions such as reverting to a prior version of the model may be performed; otherwise, the model is validated and may continue to be used. The validation may be performed periodically. In various embodiments, each validation includes one or more stages. The stages may include, but are not limited to, metrics validation, scoring validation, features validation, or a combination thereof.

In an embodiment, a machine learning model is validated with respect to metrics. In such an embodiment, the trained machine learning model is run and metrics including precision and recall are determined based on the output of the machine learning model. If each of the metrics is above a respective threshold as compared to a baseline, the model is validated; otherwise, the model is not validated. The baseline used for metrics validation may be a result of a prior run of the model.

In another embodiment, the machine learning model is validated with respect to scoring. The machine learning model is run as part of a statistical testing process. Based on the statistical testing for two runs of the machine learning model, distributions of scores are determined. The determined score distributions are compared to determine whether the newer distribution is similar or dissimilar to the older score distribution which is used as a baseline. The comparison includes isolating a rightmost portion of each score distribution and comparing values of the isolated portions. When the newer score distribution is similar to the older score distribution, the model is validated; otherwise (e.g., when an average of the newer score distribution deviates significantly from that of the older score distribution), the model is not validated.

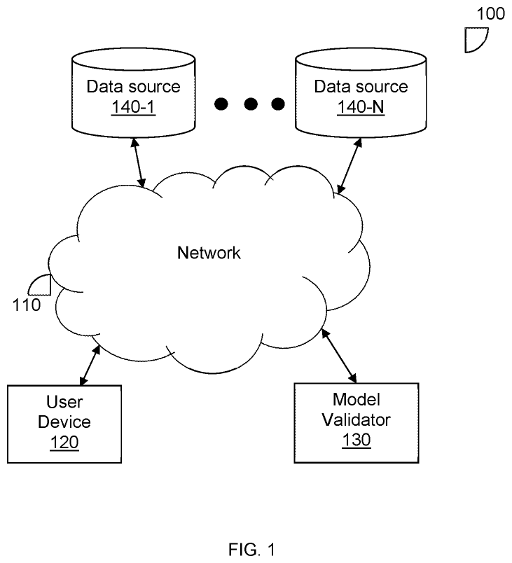

FIG. 1 shows an example network diagram 100 utilized to describe the various disclosed embodiments. In the example network diagram 100, a user device 120, a model validator 130, and a plurality of data sources 140-1 through 140-N (hereinafter referred to individually as a data source 140 and collectively as data sources 140, merely for simplicity purposes) communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The user device (UD) 120 may be, but is not limited to, a personal computer, a laptop, a tablet computer, a smartphone, a wearable computing device, or any other device capable of receiving and displaying notifications. The user device 120 may be a user device of an admin or other person seeking to have a machine learning model trained and validated, and may be configured to run and continue training the machine learning model until the model is determined to not be validated.

The data sources 140 may be databases or other sources of data used for training, validating, or applying the machine learning model as described herein. When the machine learning model is trained using a supervised training process, the data sources 140 may store labeled training sets used for such supervised learning. Instead of or in addition to databases, the data sources 140 may include sources of raw data such as network scanners or other systems configured to collect data about devices communicating with each other.

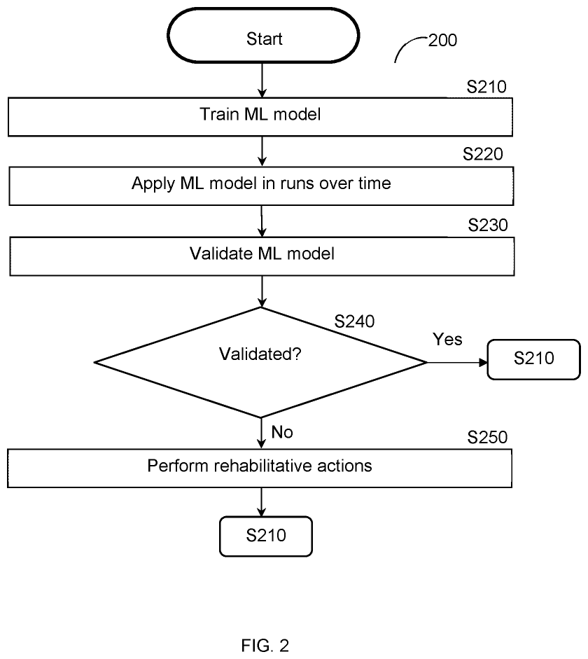

FIG. 2 is an example flowchart 200 illustrating a method for training a machine learning model using validation according to an embodiment. In an embodiment, the method is performed by the model validator 130, FIG. 1.

At S210, a machine learning model is trained. The machine learning model is trained using a training data set created based on historical data. The training may be supervised, unsupervised, or semi-supervised.

In some embodiments, the model may be trained for purposes such as, but not limited to, identifying device attributes based on conventions used for text included in string fields of device data. An example of such a model and how such a model might be trained is described further in U.S. patent application Ser. No. 17/344,294, assigned to the common assignee, the contents of which are hereby incorporated by reference. When an ensemble of models is trained, each model of the ensemble may be validated in accordance with the disclosed embodiments.

At S220, the machine learning model is applied over time in one or more runs. In an embodiment, the machine learning model is applied over multiple runs in order to allow for metrics or scoring validation by comparing results of a newer run to an older run used as a baseline. Each run includes applying the machine learning model to a test data set including data collected over a period of time. In some embodiments, a test data set is created based on a subset of the data used to create the training data set.

Each run of a machine learning model is an application of the machine learning model to test data from a discrete period of time. In various implementations, different runs whose results are compared for validation are runs over the same length of time, where the length of time used for each run may depend on the specific use case. As a non-limiting example, two runs may each be executed during a time period of one week such that results of applying the model to test data from a first week are compared to results of applying the model to test data from a second week.

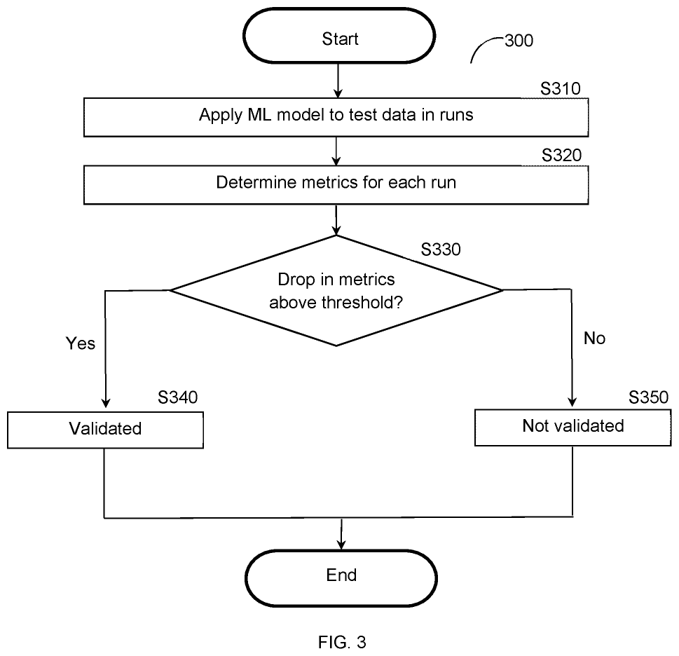

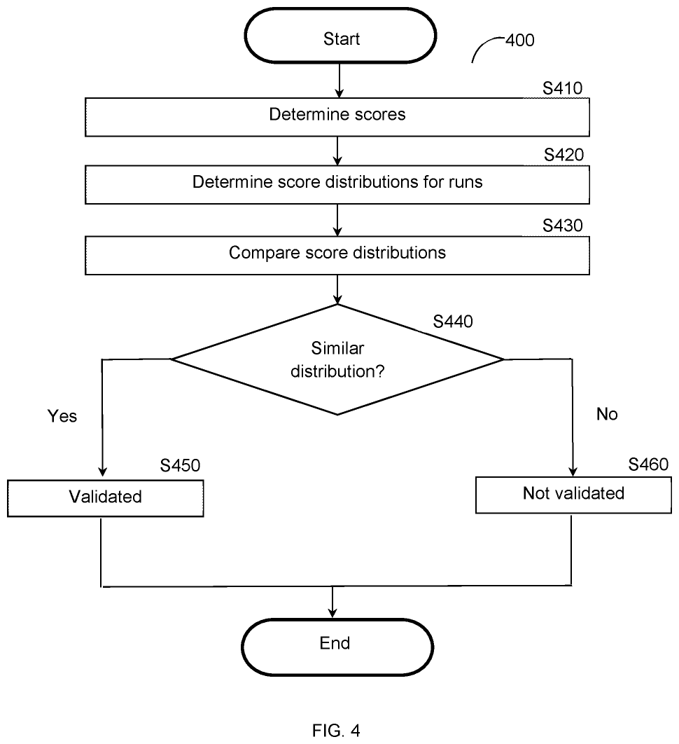

At S230, a validation process is performed with respect to the machine learning model. In an embodiment, the validation process further includes, but is not limited to, validating the machine learning model with respect to metrics, scoring, or both. Such a metrics validation process is performed as described with respect to FIG. 3, and such a scoring validation process is performed as described with respect to FIG. 4.

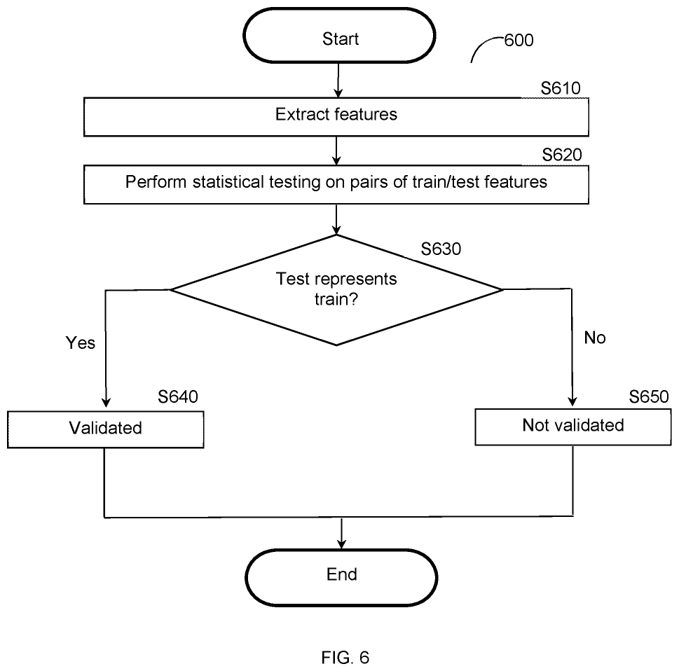

In another embodiment, S230 further includes validating the features to which the model should be applied. To this end, in such an embodiment, at least the features validation of S230 may be performed immediately prior to applying the model to the features. An example process for validating features to be input to a model is described further below with respect to FIG. 6.

In an embodiment, for each validation subprocess that is performed (e.g., either or both of validating metrics and scores), the model must be determined to be valid at each subprocess in order for the machine learning model to be determined as being valid.

At S240, it is checked whether the validation process resulted in determining that the machine learning model was validated and, if so, execution continues with S210 where training and/or application of the model continues; otherwise, execution continues with S250.

At S250, when it is determined that the model is invalid because the model is not validated, one or more rehabilitative actions are performed. The rehabilitative actions may include, but are not limited to, reverting to a previous version of the model (e.g., the most recently validated version of the model) for the next iteration of training and/or application.

In some embodiments, S250 may further include generating an alert when the model is not validated. The alert may allow, for example, for alerting an administrator or other operator to promptly identify the issue and evaluate potential root causes. Alerts generated based on the validation processes described herein provide highly credible indications that a machine learning model is no longer performing as well as needed.

FIG. 3 is an example flowchart 300 illustrating a method for metrics validation according to an embodiment.

At S310, the machine learning model is applied to test data sets over multiple runs. Each test data set includes data collected over a period of time. The duration of each period of time may depend on the use of the machine learning model. As a non-limiting example, the period of time for a run of a machine learning model trained to determine device attributes based on string conventions may be a week.

In an embodiment, the multiple runs include an older run and a newer run. The older run occurs during a period of time that is before the period of time for the newer run, and is used as a baseline to which the newer run is compared. The older run may be any prior run for which the model is presumably valid such as, but not limited to, a previous run for which the model was validated (e.g., a run immediately following an initial validation of the model or a run evaluated during a prior iteration of the method). In a further embodiment, the older run is the most recent prior run for which the model was validated. Use of the most recently validated model as the older model effectively allows for defining a rolling baseline which changes over time.

At S320, based on the application of the machine learning model to the test data sets, metrics related to performance of the machine learning model are determined for each run. In an embodiment, the determined metrics for each run include at least recall. In a further embodiment, the determined metrics also include precision.

In an embodiment where the machine learning model being validated is a classifier configured to classify inputs into various classes, S320 further includes determining, for each class, a factored standard deviation. This factored standard deviation, in turn, may be compared to previously determined standard deviations computed across known under-performing data sets. In this regard, the previously determined standard deviations of under-performing data sets may be utilized as thresholds to determine whether the metrics for the newer run of the model demonstrate that the newer model is underperforming.

At S330, it is determined whether the metrics have dropped (decreased) above a threshold between the older run and the newer run. If the drop in each metric is below a respective threshold, execution continues with S340 at which the model is determined as validated; otherwise, execution continues with S350 at which it is determined that the model is not validated. In an embodiment, S330 may include comparing the factored standard deviation determined for each metric to one or more of the threshold standard deviations determined based on known under-performing data sets.

FIG. 4 is an example flowchart 400 illustrating a method for scoring validation according to an embodiment.

At S410, scores for output of a machine learning model are determined. The scores may represent, for example, confidence levels indicating a confidence of the outputs of the machine learning model.

In an embodiment, the multiple runs include an older run and a newer run. The older run occurs during a period of time that is before the period of time for the newer run. The older run may be any prior run for which the model is presumably valid such as, but not limited to, a previous run for which the model was validated (e.g., a run immediately following an initial validation of the model or a run evaluated during a prior iteration of the method). In a further embodiment, the older run is the most recent prior run for which the model was validated. Use of the most recently validated model as the older model effectively allows for defining a rolling baseline which changes over time.

At S420, score distributions are determined. In an embodiment, a score distribution of a class of each model is determined for the period of time in which the statistical testing was run. The specific period of time to be utilized may depend on the use case. As a non-limiting example, for models trained to identify device attributes based on string conventions, the period of time may be a week such that a score distribution is determined with respect to a class of each model for every week of the statistical testing (if the statistical testing only includes a week's worth of testing, then a single score distribution is determined with respect to the class of each model).

At S430, the determined score distributions for the older and newer runs are compared. In an embodiment, S430 includes isolating a portion of each score distribution including a high score and comparing the isolated portions.

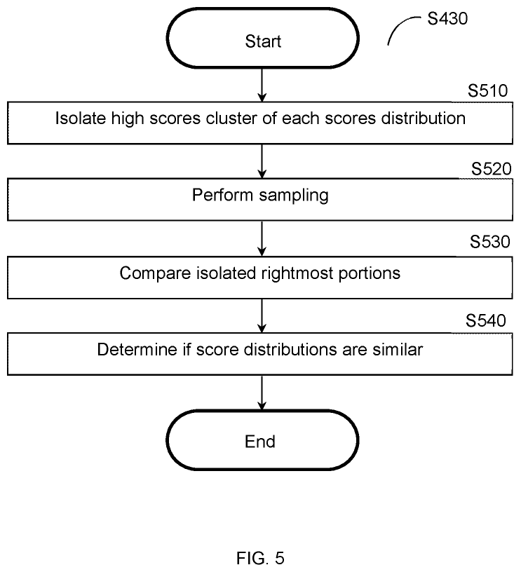

In this regard, it has been identified that scores for some types of models may not follow a normal distribution such that comparing the score distributions for different runs of the model directly may result in false negatives (i.e., identifying mismatches when the model's performance has not actually degraded significantly). To this end, in an embodiment, respective portions of each score distribution may be compared, for example, as described with respect to FIG. 5.

FIG. 5 is an example flowchart S430 illustrating a method for comparing score distributions based on high scores clusters according to an embodiment.

At S510, a high scores cluster is isolated for each score distribution to be compared. Each isolated high scores cluster is a portion of the respective score distribution including a high score. In an embodiment, each isolated high score cluster is a rightmost portion of the respective score distribution.

In an embodiment, S510 includes applying a mixture model for representing the presence of subpopulations within an overall population in order to identify and extract the high scores cluster as one of those subpopulations. In an example implementation, extraction of the high scores cluster is performed using a Gaussian Mixture Model (GMM).

In this regard, it has been identified that, for certain types of data, the score distributions do not follow a typical normal distribution such that comparing the entirety of different score distributions will result in false negatives (i.e., the score distributions will always be determined to be abnormally different). Moreover, for certain types of data having score distributions with multiple peaks, the rightmost peak having the high scores within the score distribution (when the scores are arranged from left to right in a graphical representation of the score distribution) may contain the true predictions (whereas other predictions may be false). Consequently, for such types of data, the rightmost peak is the portion which best represents the score distribution such that validating based only on a portion of the score distribution including this rightmost peak allows for more accurately validating the model than other peaks of the score distribution.

In particular, as noted above, the machine learning model may be trained to identify device attributes based on string conventions, for example as described further in the above-referenced U.S. patent application Ser. No. 17/344,294. The rightmost part of the score distribution (when the scores are arranged from left to right in a graphical representation of the score distribution) including the last peak, which also represents the high scores among the score distributions, is the relevant portion of this score distribution for comparison. Accordingly, by isolating this portion of the score distribution for a newer run of the machine learning model, this portion can be applied over the respective portion of the score distribution for an older run of the model in order to accurately determine whether the newer run is similar as compared to the older run. Applying only the isolated rightmost portions of the score distributions provides more stable comparison results than comparing the entire score distributions.

At optional S520, sampling is performed to extract a sample from each isolated high scores cluster. In an embodiment, S520 further includes fitting a subset of each high scores cluster into a Gaussian Density Estimator (GDE), from which a sample can be drawn. Using GDE and sampling for a classifier model allows for balancing anomaly volumes for an imbalanced classes environment, thereby improving accuracy of validation results.

At S530, the isolated rightmost portions. The comparison may include, but is not limited to, performing statistical testing with respect to the isolated portions. In an embodiment, the statistical testing is performed on the extracted samples. In an example implementation, the statistical testing includes T-test, an inferential statistical test used to determine a difference between the means of two groups. To this end, in an embodiment, S530 includes determining a difference between two high scores clusters based on their respective means and standard deviations. The T-test may be performed using a two-sided null hypothesis and under the assumption that two independent samples have identical averages. As noted above, isolating high scores clusters may allow for this T-test because, while the entire scores distribution may not follow a normal distribution, a high scores cluster may follow a normal distribution or other repeated distribution shape such that results of different runs may be effectively compared.

At S540, based on the statistical testing, it is determined if each newer score distribution is similar to an older score distribution. In an embodiment, a newer score distribution is similar to an older score distribution if each value of the isolated rightmost portion of the score distribution is within a predetermined threshold of a respective value (i.e., corresponding values in the overlay) of the older score distribution. In an embodiment, if the mean of a high scores cluster (or sample) of the newer data set is above a threshold value different than the corresponding mean of the high scores cluster or sample of the older data set with respect to their respective standard deviations (i.e., the standard deviations of the newer data set and of the older data set, respectively), the newer score distribution is determined to be dissimilar to the older score distribution; otherwise, the newer score distribution is determined to be similar to the older score distribution.

It should be noted that various embodiments described herein are discussed with respect to isolating rightmost portions of score distributions, but that a person having ordinary skill in the art would understand that the portion of be isolated may be in a different position relative to the graph depending on the way in which the score distribution is graphed. The disclosed embodiments are equally applicable to use of high scores clusters as described herein regardless of how those high scores clusters are arranged relative to a graph in any particular implementation.

Returning to FIG. 4, at S440, it is checked whether the score distribution of the newer run has been determined to be similar to the older score distribution based on the comparison. If the newer score distribution is similar to the older score distribution, execution continues with S450 where the model is determined as validated; otherwise, execution continues with S460 where it is determined that the model is not validated. As noted above, in an embodiment, two distributions are similar when their respective means are within a threshold of each other given their respective standard deviations.

FIG. 6 is an example flowchart 600 illustrating a method for validating features according to an embodiment.

At S610, features to be input to a machine learning model are extracted from a test data set. In an example implementation where the machine learning model is trained to identify device attributes based on string conventions, the extracted features may include strings extracted from particular portions of device data or portions thereof. In a further example, the features may include subsets of device names such as, but not limited to, substrings of a particular length (e.g., 6 characters per substring).

At S620, statistical tests are performed on pairs of features including the test features and features from a baseline features set. Each pair of features on which statistical tests are performed includes a feature from the extracted input features and a corresponding feature from the baseline features set. In an embodiment, the baseline feature set includes features extracted during a training phase for the machine learning model.

In an example implementation, the statistical tests are performed using a nonparametric test of equality of probability distributions such as, but not limited to, the Kolmogorov-Smirnov (K-S) test. The K-S test may be performed under a two-sided null hypothesis that the two samples used for the test are drawn from the same continuous distribution in order to determine the degree to which the test feature distribution deviates from the training (baseline) feature distribution. To this end, in an embodiment, S620 further includes separately fitting a vector extracted from the test data set and a vector extracted from a training data set into a GDE, from which a sample is drawn and used for the K-S test.

In this regard, it has been identified that, for a machine learning model to perform well, its underlying feature data used for the train and test phases should be drawn from the same distribution. When the feature data used for training are different from the feature data used for testing, distributions tend to differ. Thus, performing a K-S test using the null hypothesis that the vectors extracted from the respective data sets are drawn from the same distribution allows for determining if the features distribution for the test data set is skewed and therefore would reduce the accuracy of the output of any model which is applied to the features.

At S630, it is determined whether the test features (i.e., the extracted input features from the test data set) effectively represent the train features and, if so, execution continues with S640 where the test features are determined to be validated; otherwise, execution continues with S650 where the test features determined not to be validated. In an example implementation, the extracted input features are determined to effectively represent the train features when a quantified distance determined per the Kolmogorov-Smirnov test is less than a threshold; otherwise, the extracted input features are determined to not effectively represent the train features. In an embodiment, a machine learning model is applied to the test features when the test features are validated and, otherwise, application of the machine learning model to the test features is avoided.

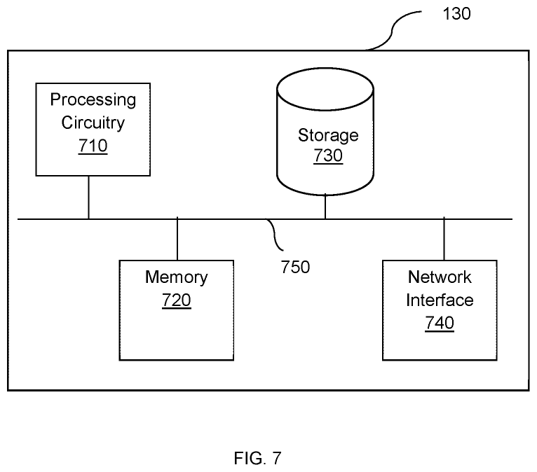

FIG. 7 is an example schematic diagram of a model validator 130 according to an embodiment. The model validator 130 includes a processing circuitry 710 coupled to a memory 720, a storage 730, and a network interface 740. In an embodiment, the components of the model validator 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the model validator 130 to communicate with, for example, the user device 120, the data sources 140, both, and the like.

It should be understood that the embodiments described herein are not limited to the specific architecture illustrated in FIG. 7, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for machine learning model validation, comprising:
determining a first score distribution for a first run of a machine learning model and a second score distribution for a second run of the machine learning model, wherein the first run includes applying the machine learning model to a first test dataset, wherein the second run includes applying the machine learning model to a second test dataset, wherein the second test dataset is collected after the first test dataset;
comparing the first score distribution to the second score distribution, wherein comparing the first score distribution to the second score distribution further comprises isolating a first high scores cluster for the first score distribution and a second high scores cluster for the second score distribution and comparing at least a portion of the first and second high scores clusters;
determining, based on the comparison, whether the machine learning model is validated;
continuing use of the machine learning model when it is determined that the machine learning model is validated; and
performing at least one rehabilitative action with respect to the machine learning model when it is determined that the machine learning model is not validated.

2. (canceled)

3. The method of claim 1, wherein comparing the first score distribution to the second score distribution further comprises:
determining a difference between the first high scores cluster and the second high scores cluster based on a mean of the first high scores cluster, a mean of the second high scores cluster, a standard deviation of the first high scores cluster, and a standard deviation of the second high scores cluster, wherein the machine learning model is determined as not validated when a difference between the first high scores cluster and the second high scores cluster is above a threshold.

4. The method of claim 1, wherein each of the first high scores cluster and the second high scores cluster is a rightmost portion of the respective score distribution.

5. The method of claim 1, further comprising:
sampling from each of the first high scores cluster and the second high scores cluster in order to obtain a first sample and a second sample, wherein the compared at least a portion of the first and second high scores clusters includes the first sample and the second sample.

6. The method of claim 1, wherein isolating each of the first high scores cluster and the second high scores cluster further comprises applying a Gaussian Mixture Model to the respective score distribution.

7. The method of claim 1, further comprising:
determining a recall for each of the first run and the second run; and
comparing the recall for the first run with the recall for the second run in order to determine whether the recall has decreased more than a threshold between the first run and the second run, wherein the machine learning model is determined as not validated when the recall has decreased more than the threshold between the first run and the second run.

8. The method of claim 7, wherein comparing the recall for the first run with the recall for the second run further comprises:
determining, for each of the first run and the second run, at least one standard deviation for the respective recall of the run, wherein it is determined whether the recall has decreased more than a threshold between the first run and the second run based on the determined standard deviations.

9. The method of claim 6, further comprising:
determining a precision for each of the first run and the second run; and
comparing the precision for the first run with the precision for the second run in order to determine whether the precision has decreased more than a threshold between the first run and the second run, wherein the machine learning model is determined as not validated when the precision has decreased more than the threshold between the first run and the second run.

10. A non-transitory computer readable medium having stored thereon instructions for causing a processing circuitry to execute a process, the process comprising:
determining a first score distribution for a first run of a machine learning model and a second score distribution for a second run of the machine learning model, wherein the first run includes applying the machine learning model to a first test dataset, wherein the second run includes applying the machine learning model to a second test dataset, wherein the second test dataset is collected after the first test dataset;
comparing the first score distribution to the second score distribution, wherein comparing the first score distribution to the second score distribution further comprises isolating a first high scores cluster for the first score distribution and a second high scores cluster for the second score distribution and comparing at least a portion of the first and second high scores clusters;
determining, based on the comparison, whether the machine learning model is validated;
continuing use of the machine learning model when it is determined that the machine learning model is validated; and
performing at least one rehabilitative action with respect to the machine learning model when it is determined that the machine learning model is not validated.

11. A system for machine learning model validation, comprising:
a processing circuitry; and
a memory, the memory containing instructions that, when executed by the processing circuitry, configure the system to:
determine a first score distribution for a first run of a machine learning model and a second score distribution for a second run of the machine learning model, wherein the first run includes applying the machine learning model to a first test dataset, wherein the second run includes applying the machine learning model to a second test dataset, wherein the second test dataset is collected after the first test dataset;
compare the first score distribution to the second score distribution, wherein the system is further configured to isolate a first high scores cluster for the first score distribution and a second high scores cluster for the second score distribution and compare at least a portion of the first and second high scores clusters;
determine, based on the comparison, whether the machine learning model is validated;
continue use of the machine learning model when it is determined that the machine learning model is validated; and
perform at least one rehabilitative action with respect to the machine learning model when it is determined that the machine learning model is not validated.

12. (canceled)

13. The system of claim 11, wherein the system is further configured to:
determine a difference between the first high scores cluster and the second high scores cluster based on a mean of the first high scores cluster, a mean of the second high scores cluster, a standard deviation of the first high scores cluster, and a standard deviation of the second high scores cluster, wherein the machine learning model is determined as not validated when a difference between the first high scores cluster and the second high scores cluster is above a threshold.

14. The system of claim 11, wherein each of the first high scores cluster and the second high scores cluster is a rightmost portion of the respective score distribution.

15. The system of claim 11, wherein the system is further configured to:
sample from each of the first high scores cluster and the second high scores cluster in order to obtain a first sample and a second sample, wherein the compared at least a portion of the first and second high scores clusters includes the first sample and the second sample.

16. The system of claim 11, wherein isolating each of the first high scores cluster and the second high scores cluster further comprises applying a Gaussian Mixture Model to the respective score distribution.

17. The system of claim 11, wherein the system is further configured to:
determine a recall for each of the first run and the second run; and
compare the recall for the first run with the recall for the second run in order to determine whether the recall has decreased more than a threshold between the first run and the second run, wherein the machine learning model is determined as not validated when the recall has decreased more than the threshold between the first run and the second run.

18. The system of claim 17, wherein the system is further configured to:
determine, for each of the first run and the second run, at least one standard deviation for the respective recall of the run, wherein it is determined whether the recall has decreased more than a threshold between the first run and the second run based on the determined standard deviations.

19. The system of claim 16, wherein the system is further configured to:
determine a precision for each of the first run and the second run; and
compare the precision for the first run with the precision for the second run in order to determine whether the precision has decreased more than a threshold between the first run and the second run, wherein the machine learning model is determined as not validated when the precision has decreased more than the threshold between the first run and the second run.
